(19) United States
(12) Patent Application Publication
(10) Pub. No.: US 2005/0017228 A1
(43) Pub. Date: Jan. 27, 2005

(54) Winch control method and apparatus

(76) Inventor: Peter Harold Werner, West Bend, WI (US)

Correspondence Address: Susan M. Donahue;Rockwell Automation, Inc., 1201 South Second Street, 704-P, Milwaukee, WI, 53204-2496, US

(21) Appl. No.: 10/626,898

(22) Filed: Jul. 22, 2003

(51) Int. Cl. B66D 1/26

(52) U.S. Cl. 254/278

(57) ABSTRACT

A method and apparatus for use with a transfer system for transferring a trolley between first and second stations, the system including an inhaul winch, an outhaul winch, a cable and a trolley, the inhaul winch mounted to the first station, the outhaul winch mounted to one of the first and second stations, the cable extending between the first and second stations and between the inhaul and outhaul winches and the trolley mounted to the cable, the assembly for controlling trolley speed during transfer between the first and second stations and comprising a speed selector for setting a command speed value, a speed sensor assembly sensing the speed of the cable and providing a speed feedback value and a speed regulator regulating the speeds of the inhaul and the outhaul winches as a function of the command speed value and the speed feedback value.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates to an article transfer system including two winches and a cable that traverses the distance between two stations where the relative juxtaposition between the stations may change during article transfer and more specifically to a cable speed/tension control system for such a winch/cable configuration.

The present invention has various applications in both the military and civilian shipping industries including transfer of articles and/or people between two ships or between a dock and a ship. Nevertheless, unless indicated otherwise, the present invention will be described in the context of a process and system for transferring supplies between a military replenishment ship and a military receiving ship requiring the supplies.

Ships and other sea going vessels often spend long periods (e.g., several days, weeks or even months) out of port. To support on-board activities during these long periods at sea, typically large amounts of supplies have to be transferred to a ship for storage and subsequent use. The preferred way to transfer supplies to a ship is to have the ship dock at a port and transfer the supplies portside. Unfortunately, in the case of some ships, the potential for nefarious activities renders some ports unsafe. For instance, in the case of military ships, it is often preferred to keep military ships out of unguarded ports during replenishment activities to avoid potential illicit activities.

To facilitate at sea transfer of supplies, winch/cable systems have been developed that enable ship-to-ship supply transfers. Here, the idea is that a replenishment ship loads supplies in port, leaves port to rendezvous with a receiving ship at sea (i.e., out of port) and transfers the supplies to the receiving ship at sea.

To accomplish at sea transfer of supplies, a typical winch/cable transfer system includes an inhaul winch and an outhaul winch that are proximately mounted on one side of a replenishment ship and a pulley assembly mounted to a side of the receiving ship that faces the replenishment ship. A first end of a cable is received by the inhaul winch, a second end of the cable is received by the outhaul winch and the central portion of the cable extends between the replenishment ship and the receiving ship and is restricted by the pulley assembly. Thus, the cable traverses from the inhaul winch on the replenishing ship to the pulley on the receiving ship and then from the pulley to the outhaul winch on the replenishing ship. Unless indicated otherwise the cable section between the pulley and the inhaul winch will be referred to hereinafter as the inhaul cable section and the section between the pulley and the outhaul winch will be referred to as the outhaul cable section.

A trolley or carriage for supporting articles for transfer is secured to the inhaul cable section for movement therewith. To move the carriage from the replenishing ship to the receiving ship, the inhaul winch rotates to let cable out while the outhaul winch takes cable in. Similarly, to move the carriage from the receiving ship back to the replenishing ship, the outhaul winch rotates to let cable out while the inhaul winch takes cable in. Hereinafter movement form the replenishing ship toward the receiving ship will be referred to as an outhaul activity or “outhauling” and movement from the receiving ship to the replenishing ship will be referred to as an inhaul activity or “inhauling” (i.e., movement will be referred to relative to the replenishing ship).

A typical winch/cable control system includes a user operated control handle or throttle located at an operator's observation deck—the deck being located on the replenishing ship at a best location for observing system operations. The throttle facilitates simultaneous adjustment of both the inhaul and outhaul winches so that operation of the two winches can be essentially synchronized. The throttle has inhaul and outhaul directions and typically enables a range of load dependent inhaul and outhaul speeds. Typically, to adjust trolley speed, a system operator acts as a feedback system by visually observing trolley movement between the replenishing and receiving ships and throttling speed appropriately—e.g., speed is generally increased and decreased by altering throttle position.

Trolley speed control is important for various reasons. First, often the amount of supplies that have to be transferred between ships is relatively large. Large supply transfer requirements coupled with a general requirement that transfer periods be kept to a minimum (especially in the case of military replenishment activities where ships may be relatively more vulnerable during replenishment activities) means that high speed transfer is a high priority in many applications.

Second, while trolley speed should be high when a trolley is safely away from each of the replenishing ship and the receiving ship, trolley speed should be much lower and relatively precisely controlled when a trolley is located proximate either of the replenishing ship or the receiving ship to avoid potential damage to the articles being transferred, the trolley, the cable and/or to ship structure.

Exacerbating transfer tasks and increasing the likelihood of damage to articles being transferred and/or system components, during ship-to-ship transfers that take place outside protected ports, unpredictable sea swells and waves cause adjacent ships to heave, bob and roll according to different cycles so that relative juxtapositions of the replenishing ship winches and the receiving ship pulley assembly change in non-determinant ways. For instance, if a replenishing ship and a receiving ship linked thereto both roll toward each other at the same time the vertical height of a trolley therebetween may drop rapidly toward the surface of the sea there below. Similarly, if the replenishing ship and the receiving ship roll away from each other at the same time vertical height may change rapidly (e.g., an upward sling-shot activity may result in this case). Slow trolley speeds proximate ships reduce the likelihood of system component damage.

Rapid changes in vertical trolley height can be approximated by cable tensions and thus cable tensions can be adjusted to compensate for relative ship heaving, rolling and bobbing thereby generally maintaining control of vertical trolley height. Thus, for instance, where adjacent cable linked ships roll toward each other at the same time the cable tensions of each of the inhaul and outhaul cable sections are reduced appreciably. Here, winch control can be used to maintain a constant cable tension such that the vertical position of the trolley is essentially maintained. Similarly, where adjacent cable linked ships roll away from each other at the same time, the cable tensions of each of the inhaul and outhaul cable sections are increased appreciably. Here, again, winch control can be used to maintain a constant cable tension such that the vertical position of the trolley is essentially maintained.

An exemplary tension regulating system includes inhaul and outhaul tension sensors associated with the inhaul and the outhaul winches, respectively. Each sensor generates a tension signal which is fed back to a winch controller. The controller compares the tension feedback signals to previous tension signals and adjusts winch cable intake and cable output to maintain constant cable tensions and hence to generally maintain trolley height during transfer.

Unfortunately, while control systems like the ones described above work well in theory, these systems have failed to provide accurate trolley speed control. In this regard, as in most throttle based control systems, trolley speed is a function of both power into the winch and the load associated with the winch. Thus, for instance, for a given throttle position, all other factors assumed equal, a first load may have a higher speed than a second load where the second load is three times as heavy as the first load.

In addition, even for a specific article to be transferred, the effective load on winches may vary so that trolley speed is different despite the same throttle position. For instance, in one case, assume that a receiving ship deck is 30 feet above the winches on the replenishing ship while in another case the receiving ship deck is 20 feet below the winches. Here, despite the same article to transfer, the loads on the winches differ appreciably and a single throttle position would result in two different speeds.

Moreover, in a typical case, winch load changes during article transfer activity and the load changes affect trolley speed. Here, again assume that a receiving ship deck is approximately 30 feet above the replenishing ship winches but that large sea swells cause the relative height difference to change between 25 and 35 feet. Here, during transfer, winch loads and hence trolley speed change appreciably.

Furthermore, systems that maintain cable tension, in some cases, can exacerbate the speed regulating problems described above. In this regard, some tension maintaining algorithms may cause effects that compound load varying effects of sea swells and the like. For instance, assume that a sea swell reduces a difference in height between a receiving ship deck and the replenishing ship winches so that the winch loads are generally reduced thereby increasing trolley speed. Here, as the relative vertical dimension between the winches and the receiving deck changes the tension sensors may cause the winches to maintain a constant tension which could increase trolley speed further thereby causing a compounding effect.

A problem related to varying trolley speed is that, in many applications, while a system operator will be positioned so as to have the best possible view of the overall transfer system, even the best possible view does not facilitate very good observation of activities and, more specifically, of trolley speed at the receiving ship end of the configuration. In some cases the operator's observation deck may be 20 or more yards from the receiving deck and hence visual speed determination will be poor at best.

Thus, there is a need for a controller that provides precise trolley speed control in a ship supply transfer configuration.

### BRIEF SUMMARY OF THE INVENTION

It has been recognized that a speed feedback loop can be added to a winch control system to configure a much better control configuration for use with a ship supply transfer system. The speed feedback loop enables configuration of a true speed controller as opposed to a throttle so that a winch/cable system operator can select a load-independent trolley speed by positioning a speed control input device and needn't be concerned that trolley speed will change as a function of other factors such as relative ship heaving, bobbing and rolling due to sea swells and the like. The end result is a much more controllable system in which operators become far more confident and transfer speed is increased appreciably.

In at least some inventive embodiments two cable speed sensors, an initial sensor for measuring speed of a cable section proximate the inhaul winch and an outhaul sensor for measuring speed of a cable section proximate the outhaul winch, are provided. Which cable speed signal is used in the speed loop, the outhaul or inhaul signal, is a function of whether or not the trolley is being moved in the outhaul or inhaul directions. In at least some embodiments, when the trolley is outhauling, the inhaul speed sensor signal is used for feedback and, when the trolley is inhauling, the outhaul speed sensor signal is used for feedback.

When the difference between a commanded speed and the value of the speed feedback signal is negative, the inhaul winch torque is increased while the outhaul winch torque is set to some nominal value corresponding to a minimum cable tension. For instance, if the trolley is outhauling and the speed of a section of cable proximate the inhaul winch is higher than the commanded speed, the inhaul winch torque is increased to slow the inhaul winch down thereby reducing speed. As another instance, if the trolley is inhauling and the magnitude of the speed of the section of cable proximate the outhaul winch is less than the magnitude of the commanded speed, the inhaul winch torque is increased to speed up trolley movement.

Similarly, when the difference between the commanded speed and the speed feedback signal is positive, the outhaul winch torque is increased while the inhaul winch torque is set to some nominal value corresponding to a minimum tension cable.

In at least some embodiments, in addition to the speed feedback loop, a tension feedback system is employed to maintain a suitable tension on the system cables thereby minimizing rapid changes in vertical trolley position. Here, in at least some embodiments, when the speed error (e.g., command speed less feedback speed value) is positive, the outhaul torque is set as a function of a minimum cable tension reference while the inhaul torque is set as a function of the minimum cable tension reference, an inhaul tension feedback signal and the speed error. In this way, when outhaul or inhaul speed is too slow, the outhaul winch torque increase is made a function of inhaul cable tension so that, if the inhaul cable tension is lower than a minimum value, the torque is increased more rapidly and, if the inhaul cable tension is higher than the minimum value the torque increase is slower. Similarly, when the speed error is negative, the inhaul torque is set as a function of the minimum cable tension reference while the outhaul torque is stepped up or down at a rate that depends on the cable tension proximate the outhaul winch.

Consistent with the above, the present invention includes an apparatus for use with a transfer system for transferring a trolley between first and second stations, the system including an inhaul winch, an outhaul winch, a cable and a trolley, the inhaul winch mounted to the first station, the outhaul winch mounted to one of the first and second stations, the cable extending between the first and second stations and between the inhaul and outhaul winches and the trolley mounted to the cable, the assembly for controlling trolley speed during transfer between the first and second stations and comprising a speed selector for setting a command speed value, a speed sensor assembly sensing the speed of the cable and providing a speed feedback value and a speed regulator regulating the speeds of the inhaul and the outhaul winches as a function of the command speed value and the speed feedback value.

In some embodiments the speed sensor assembly includes an inhaul speed sensor, an outhaul speed sensor and a feedback determiner, the inhaul speed sensor sensing the speed of the cable proximate the inhaul winch and generating an inhaul speed feedback signal and the outhaul speed sensor sensing the speed of the cable proximate the outhaul winch and generating an outhaul speed feedback signal, the feedback determiner selecting one or the other of the inhaul and outhaul speed feedback signals as the speed feedback value. In some embodiments, when the winches are moving the trolley from the first station toward the second station, the feedback determiner selects the inhaul speed feedback signal as the speed feedback value and, when the winches are moving the trolley from the second station toward the first station, the feedback determiner selects the outhaul speed feedback signal as the speed feedback value.

Some embodiments include a pulley mounted to the second station and wherein the outhaul winch is mounted to the first station and the cable passes from the inhaul winch around the pulley and back to the outhaul winch.

The speed sensor assembly may include first and second cable speed sensors for determining the speed of two different sections of the cable. Here, the speed sensor assembly may further include a speed feedback determiner for selecting a signal from one of the first and second cable speed sensors as the speed feedback value. In some cases the first and second speed sensors include an inhaul speed sensor for sensing the speed of the cable proximate the inhaul winch and an outhaul speed sensor for sensing the speed of the cable proximate the outhaul winch, respectively, and, wherein, the speed feedback determiner selects the inhaul sensor signal when the inhaul winch is letting cable out and selects the outhaul sensor signal when the outhaul winch is letting cable out.

The speed regulator may include a summer that mathematically combines the command speed value and the speed feedback value to generate a speed error value and then uses the speed error value to adjust inhaul and outhaul winch speeds. Here, when the speed error value is positive, the speed regulator may use the speed error value as an intermediate outhaul speed value to control the outhaul winch and a zero intermediate inhaul speed value to control the inhaul winch and, when the speed error value is negative, the speed regulator may use the speed error value as an intermediate inhaul speed value to control the inhaul winch and a zero intermediate outhaul speed value to control the outhaul winch.

The apparatus may further include a tension selector for setting a command tension value, the speed regulator mathematically combining the command tension value and the intermediate inhaul speed value to generate an inhaul torque value to control the inhaul winch speed and mathematically combining the command tension value and the intermediate outhaul speed value to generate an outhaul torque value to control the outhaul winch speed. The apparatus may further include inhaul and outhaul tension sensors for sensing cable tensions proximate the inhaul and outhaul winches and generating inhaul and outhaul tension feedback values, respectively, when the error signal is negative, the speed regulator mathematically combining to generate the outhaul torque value by mathematically combining the command tension value and the outhaul tension feedback value to generate an intermediate outhaul tension value, mathematically combining the command tension value and the intermediate outhaul tension value to generate a final outhaul tension value and mathematically combining the intermediate outhaul speed value and the final outhaul tension value to generate the outhaul torque value; and, when the error signal is positive, the speed regulator mathematically combining to generate the inhaul torque value by mathematically combining the command tension value and the inhaul feedback tension value to generate an intermediate inhaul tension value, mathematically combining the command tension value and the intermediate inhaul tension value to generate a final inhaul tension value and mathematically combining the intermediate inhaul speed value and the final inhaul tension value to generate the inhaul torque value. The summer may mathematically combine the command speed value and the speed feedback value by subtracting the speed feedback value from the command speed value.

Some embodiments further include a cable tension selector for selecting a cable tension command value, the speed regulator regulating the speeds of the inhaul and the outhaul winches as a function of the command speed value, the speed feedback value and the cable tension command value. Here, the apparatus may further include an inhaul cable tension sensor and an outhaul cable tension sensor for sensing the tension of the cable proximate the inhaul and outhaul winches and generating inhaul and outhaul tension feedback values, respectively, the speed regulator regulating the speeds of the inhaul and the outhaul winches as a function of the command speed value, the speed feedback value, the cable tension command value and the inhaul and outhaul tension feedback values.

The speed sensor assembly in some cases includes first and second cable speed sensors for determining the speeds of two different sections of the cable and wherein the speed sensor assembly further includes a speed feedback determiner for selecting a signal from one of the first and second cable speed sensors as the speed feedback value.

The invention also includes an apparatus for use with a transfer system for transferring a trolley between first and second stations, the system including an inhaul winch, an outhaul winch, a cable, a trolley and a pulley, the inhaul winch and outhaul winch mounted to the first station, the pulley mounted to the second station, the cable extending from the inhaul winch to the pulley and back to the outhaul winch and the trolley mounted to the cable, the assembly for controlling trolley speed during transfer between the first and second stations and comprising a speed selector for setting a command speed value, the command speed value positive when the winches are operating to move the trolley toward the second station and negative when the winches are operating to move the trolley toward the first station, an inhaul speed sensor for sensing cable speed proximate the inhaul winch and generating an inhaul speed feedback value, an outhaul speed sensor for sensing cable speed proximate the outhaul winch and generating an outhaul speed feedback value, a speed feedback determiner that selects the inhaul speed feedback value as a speed feedback value when the command speed value is positive and selects the outhaul speed feedback value as the speed feedback value when the command speed value is negative and a speed regulator that regulates the torques of the inhaul and the outhaul winches as a function of the command speed value and the speed feedback value.

The invention further includes a method for use with a transfer system for transferring a trolley between first and second stations, the system including an inhaul winch, an outhaul winch, a cable, a trolley and a pulley, the inhaul winch and outhaul winch mounted to the first station, the pulley mounted to the second station, the cable extending from the inhaul winch to the pulley and back to the outhaul winch and the trolley mounted to the cable, the method for controlling trolley speed during transfer between the first and second stations and comprising the steps of providing a command speed value that is positive when the trolley is being moved from the first toward the second station and that is negative when the trolley is being moved from the second to toward the first station, identifying an inhaul speed feedback value by determining the speed of a section of the cable proximate the inhaul winch, identifying an outhaul speed feedback value by determining the speed of a section of the cable proximate the outhaul winch, when the command speed value is positive, selecting the inhaul speed feedback value as a speed feedback value, when the command speed value is negative, selecting the outhaul speed feedback value as a speed feedback value and regulating winch torques as a function of the command speed value and the speed feedback value.

Furthermore, the invention includes a transfer assembly for transferring between first and second stations, the assembly comprising an inhaul winch mounted to the first station, an outhaul winch mounted to one of the first and second stations, a cable extending between the first and second stations and between the inhaul and outhaul winches, a trolley mounted to the cable, a speed selector for setting a command speed value, a speed sensor assembly sensing the speed of the cable and providing a speed feedback value and a speed regulator regulating the speeds of the inhaul and the outhaul winches as a function of the command speed value and the speed feedback value.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a schematic diagram illustrating a transfer assembly according to the present invention wherein a replenishment ship deck is vertically higher than a receiving ship deck;

FIG. 2 is a is similar to FIG. 1, albeit illustrating a system wherein the replenishment ship deck is vertically below the receiving ship deck;

FIG. 3 is a schematic diagram illustrating four quadrants of trolley control where the quadrants are a function of outhaul to inhaul cable differential and trolley speed;

FIG. 4 is a schematic diagram of a control system according to one embodiment of the present;

FIG. 5 is a schematic diagram of a section of a control system that may be used to replace a section of the control system of FIG. 4 and that includes a closed tension loop;

FIG. 6 is a flow chart illustrating one method according to the present invention; and

FIG. 7 is similar to FIG. 6 albeit illustrating a second method according to the present invention.

### DETAILED DESCRIPTION OF THE INVENTION

Hereinafter, unless indicted otherwise, an “*” will be used to identify reference or command signals, a subscript “e” will used to indicate an error signal, a “fb” will be used to indicate a feedback signal, a subscript “o” will be used to indicate a signal associated with either an outhaul winch or a section of cable proximate an outhaul winch, a subscript “i” will be used indicate a value associated with an inhaul winch or a section of cable proximate an inhaul winch, a subscript “int” will be used to indicate an intermediate value and subscript “f” will be used to indicate a final value. In some cases subscripts identified above will be combined to indicate several characteristics of a signal associated therewith. For example, the symbol S_{fbo} will be used hereinafter to indicate a feedback speed signal corresponding to a section of cable proximate an outhaul winch. Similarly, the symbol Sᵢₙₜᵢ will be used to refer to an intermediate speed signal associated with an inhaul winch. Also, to simplify this explanation, the phrases “inhaul cable tension” and “outhaul cable tension” will be used to refer to the sections of a cable proximate an inhaul winch and an outhaul winch, respectively.

A. Overview of Transfer Components

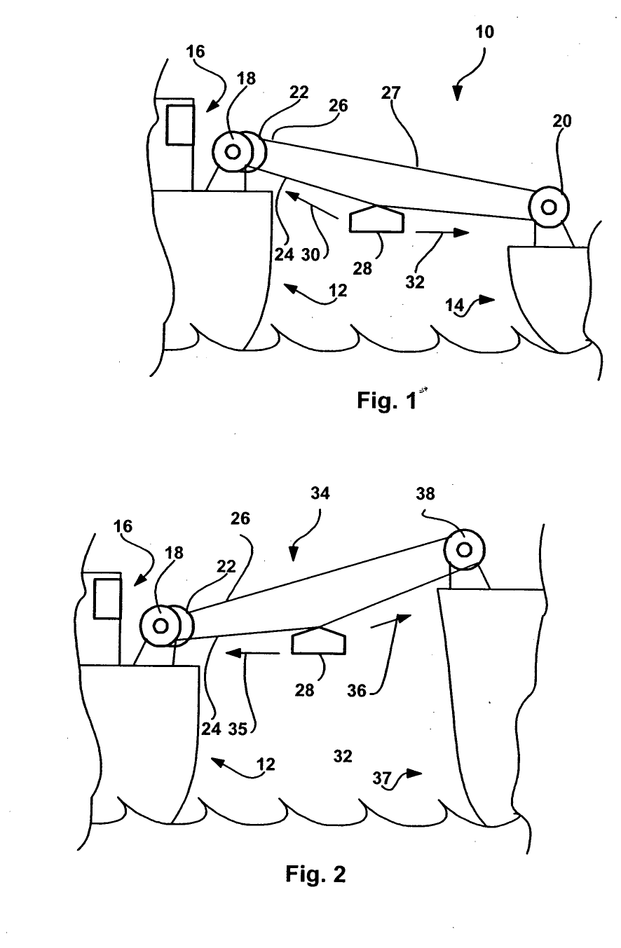

Referring now to the drawings and, more specifically, referring to FIG. 1, the present invention will be described in a context of an exemplary ship to ship replenishment system 10. In FIG. 1, a replenishment ship 12 is employed to transfer a trolley 28 and items thereon to a receiving ship 14. To accomplish this task, ship 12 includes an elevated operator observation and control station 16, an inhaul winch assembly 18 and an outhaul winch assembly 22. The inhaul and outhaul winch assemblies 18 and 22, respectively, are mounted to the replenishment ship deck in a rigid fashion and adjacent one side of the ship.

A receiving ship 14 includes a pulley assembly 20 mounted on the top of one of its decks and adjacent one side of the ship 14. Pulley assembly 20 cooperates with winch assemblies 18 and 22 in a manner to be described in more detail below.

In addition to the components described above, the replenishment assembly 10 also includes a high tension cable generally identified by numeral 27 which has first and second ends (not separately numbered). In a typical set up, a first end of cable 27 is received by inhaul winch assembly 18 and is wrapped around that winch assembly multiple times. Cable 27 extends from inhaul winch 18 to receiving ship 14, wraps around pulley assembly 20 and then traverses the distance back to replenishment ship 12 where the second end of cable 27 is received and wrapped around inhaul winch 22. Trolley 28 is mounted to the portion of cable 27 that extends from inhaul winch assembly 18 to pulley assembly 20.

It should be appreciated that, by simultaneously controlling inhaul and outhaul winch assemblies 18 and 22, respectively, trolley 28 attached to cable 27 can be moved in either direction between replenishment ship 12 and receiving ship 14. Hereinafter, unless indicated otherwise, when winch assemblies 18 and 22 are used to move trolley 28 from replenishment ship 12 toward receiving ship 14, the operation will be referred to as an outhaul or outhauling operation. Similarly, when winch assemblies 18 and 22 are used to move trolley 28 in the direction from receiving ship 14 to replenishment ship 12, the operation will be referred to as an inhaul or inhauling operation. Outhauling and inhauling movement are identified by arrows 32 and 30, respectively, in FIG. 1. In addition, the section of cable 27 proximate inhaul winch assembly 18 at any given time (i.e., the proximate section changes as the winch is rotated) will be referred to as the inhaul cable section 24 and the section of cable 27 proximate the outhaul winch assembly will be referred to as the outhaul cable section 26.

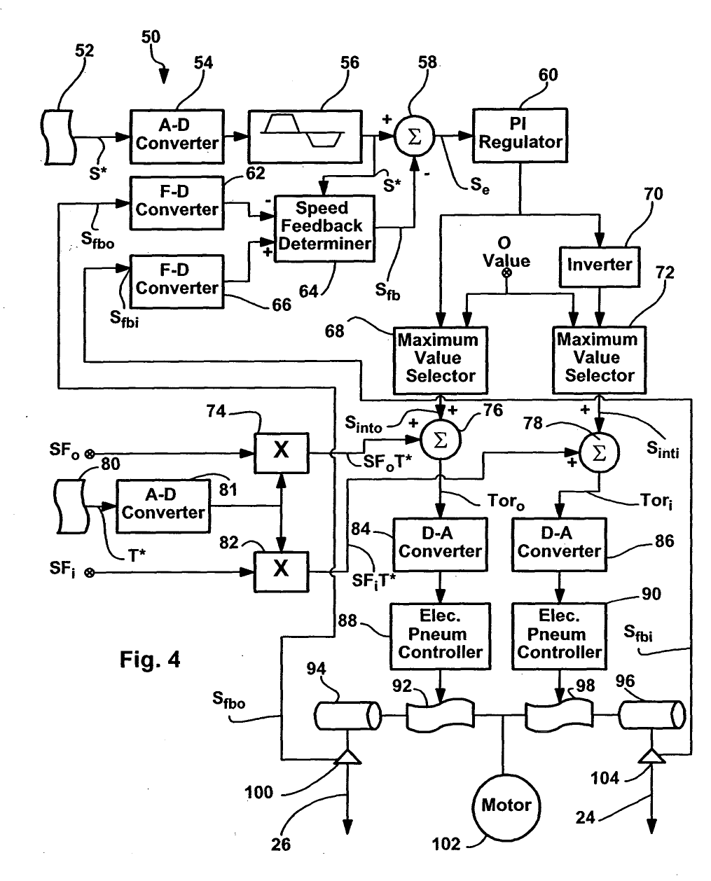

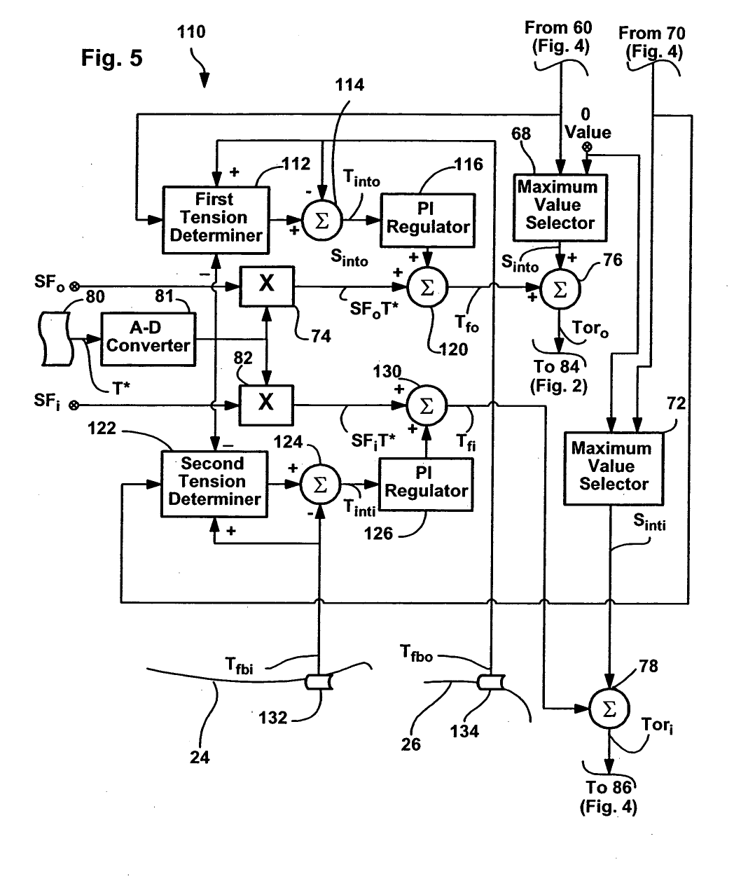

Each of the inhaul and outhaul winch assemblies 18 and 22, respectively, includes a motor, a clutch and a drum. Referring also to FIG. 4, the inhaul winch clutch and drum are identified by numerals 98 and 96, respectively, which the outhaul winch clutch and drum are identified by numerals 92 and 94, respectively. A single motor 102 is illustrated that is coupled to each of drums 94 and 96 via their associated clutches 92 and 98. Motor 102 is typically set to operate and rotate a motor rotor at a single speed. To increase torque on the drums 94 and 96 and hence winch speed, the slip between the clutches 92 and 98 and the motor rotor is decreased. Similarly, to decrease drum speed the slip between a clutch and the motor rotor is increased.

Referring again to FIG. 1, controls for controlling winch assemblies 18 and 22 are provided within station 16. Referring also to FIG. 4, among other controls, the controls provided in station 16 include a speed selector 52 and a minimum cable tension selector 80. In at least one embodiment, speed selector 52 includes a potentiometer which outputs a voltage within an appropriate range. For instance, an exemplary speed selector output may be anywhere within a range of −10 volts to +10 volts where a positive value indicates outhaul control (i.e., movement of trolley 28 from replenishment ship 12 to receiving ship 14) and a negative value indicates inhaul control. The minimum cable tension selector 80, in some embodiments, will also include a potentiometer. The output of minimum cable tension selector 80 will always be positive and, for instance, may have a range between zero and +10 volts.

B. Control Algorithm

Referring yet again to FIG. 1, in some cases the relative heights of the replenishment ship deck and the receiving ship deck will be such that the winch assemblies 18 and 22 reside at a higher elevation than the receiving pulley assembly 20. In this case, it should be appreciated that, because trolley 28 moves downward when traversing in the outhaul direction 32, trolley 28, acting under the force of gravity, in effect, pulls cable from inhaul winch assembly 18. This pulling force on assembly 18 is such that the trolley load attempts to rotate the winch drum more quickly than commanded by the system operator. Thus, when winch assemblies 18 and 22 are vertically relatively higher than pulley assembly 20 and trolley 28 is moved in outhaul direction 32, inhaul winch assembly 18 operates as a braking system to hold back trolley 28 and control trolley speed. Hereinafter, unless indicated otherwise, where trolley 28 movement results in a pulling force on one of the winch assemblies 18 or 22 in the direction of trolley movement, the condition will be referred to as an “overhauling” condition.

Referring now to FIG. 2, an exemplary system 34 similar to the system 10 illustrated in FIG. 1 is shown. The primary difference between the systems in FIGS. 1 and 2 is that the receiving ship 37 deck in FIG. 2 is much higher than the deck of receiving ship 14 in FIG. 1 such that pulley assembly 38 on receiving ship 37 is vertically relatively higher than assemblies 18 and 22 mounted to replenishment ship 12. In FIG. 2, the inhaul and outhaul directions are identified by arrows 35 and 36, respectively. Importantly, when the receiving ship pulley assembly 38 is higher than the winch assemblies 18 and 22 on the replenishment ship 12, overhauling conditions occur when trolley 28 is moving in inhauling direction 35 as opposed to outhauling direction 36. Here, the overhaul pulling force of trolley 28 is on the outhaul winch assembly 22 as opposed to the inhaul assembly 18. Hence, when moving in direction 35, trolley 28 tends to pull the cable from outhaul winch assembly 22 and winch assembly 22 operates as a brake on trolley speed.

Referring again to FIG. 1, when winch assemblies 18 and 22 are vertically relatively higher than pulley assembly 20 and trolley 28 is moving in inhauling direction 30, a normal load condition occurs where the force exerted by trolley 28 is against the rotating directions of each of trolley assemblies 18 and 22. Similarly, in FIG. 2, a normal load condition occurs when trolley 28 is moved in outhauling direction 36.

In addition to the conditions described above, there are two other interesting operating conditions including accelerating and decelerating conditions. With respect to trolley deceleration, deceleration generally requires one or other of the winch assemblies 18 or 22 to operate as a braking mechanism to slow trolley movement independent of whether or not the trolley is moving in the inhaul direction or outhaul direction. For example, referring again to FIG. 1, assuming trolley 28 is moving in inhaul direction 30 and hence a normal load condition occurs. In this case, to decelerate trolley 28, outhaul winch 22, at least instantaneously, operates as a braking mechanism to slow trolley movement. Similarly, referring to FIG. 2, assuming trolley 28 is moving in outhaul direction 36 and hence a normal load occurs, to decelerate trolley 28, inhaul winch assembly 18 instantaneously operates as a braking mechanism.

With respect to acceleration, regardless of whether or not trolley 28 is moving in the inhaul direction or outhaul direction, an accelerating trolley 28 results in forces on assemblies 18 and 22 that are akin to normal load forces. For instances, referring again to FIG. 1, assuming trolley 28 is moving in outhaul direction 32 and winch assemblies 18 and 22 are currently being controlled to accelerate trolley 28, instantaneously, the winch speeds are increased and, in particular, the speed of inhaul winch assembly 18 exceeds the speed at which trolley 28 pulls cable from assembly 18. Similarly, referring again to FIG. 2, when trolley 28 is moving in inhaul direction 35 and assemblies 18 and 22 are controlled to accelerate trolley 28 in inhaul direction 35, instantaneously, the rotating speed of assembly 22 increases beyond the speed at which the trolley load 28 would draw cable from assembly 22.

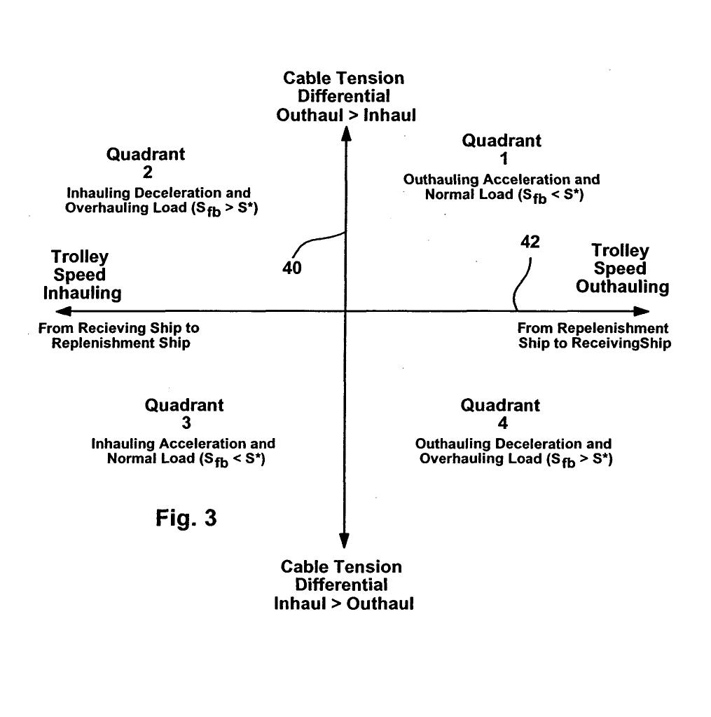

Referring now to FIG. 3, a graph showing four exemplary quadrants of system operation is illustrated. In FIG. 3, four quadrants are defined by vertical and horizontal axes 40 and 42, respectively. The vertical axis 40 corresponds to cable tension differential. The top half of axis 40 corresponds to a condition wherein the outhaul cable section 26 tension is greater than the inhaul cable section 24 tension. Similarly, the bottom half of vertical axis 40 corresponds to conditions wherein the inhaul cable section 24 tension is greater than the outhaul cable section 26 tension. The left half of horizontal axis 42 corresponds to inhauling conditions where trolley 28 is being moved from the receiving ship to the replenishment ship (e.g., from ship 14 to ship 12 in FIG. 1). The right half of horizontal axis 42 corresponds to conditions wherein trolley 28 is moving from the replenishment ship to toward the receiving ship.

Referring still to FIG. 3, the outhaul cable section 26 tension will be greater than the inhaul cable section 24 tension under several different sets of circumstances. First, referring again to FIG. 2, during a normal load condition with trolley 28 moving in outhauling direction 36, outhaul cable section 26 tension is greater than the inhaul cable section 24 tension proximate inhaul winch 18. Second, whenever outhauling and accelerating trolley 28, irrespective of whether or not the load is an overhauling load (see again FIG. 1) or a normal load (see again FIG. 2), the outhaul cable section 26 tension is greater than the inhaul cable section 24 tension. Both of these two sets of circumstances correspond to quadrant 1 in FIG. 3.

Referring still to FIG. 3, a third set of circumstances under which the outhaul cable section 26 tension will be greater than the inhaul cable section 24 tension occurs whenever trolley 28 is inhauled and operates as an overhauling load. To this end, referring again to FIG. 2, when trolley 28 is inhauled in direction 35 and pulley assembly 38 is vertically higher than winch assemblies 18 and 22 such that an overhauling condition occurs, tension of cable section 26 proximate outhaul winch assembly 22 is greater than the tension in cable section 24 proximate inhaul winch assembly 18. Fourth, the outhaul cable section 26 tension is greater than the inhaul cable tension whenever inhauling trolley 28 when winch assemblies 18 and 22 are operated to decelerate trolley 28 irrespective of whether or not trolley 28 corresponds to a normal or overhauling load. These third and fourth sets of conditions under which the outhaul cable section 26 tension is greater than the inhaul cable section 24 tension correspond to quadrant 2 in FIG. 3.

Referring once again to FIG. 3, the inhaul cable section 24 tension will be greater than the outhaul cable section 26 tension under several sets of circumstances. First, referring again to FIG. 1, whenever trolley 28 is moved in the inhaul direction 30 and operates as a normal load, the tension of cable section 24 adjacent inhaul winch assembly 18 is greater than the tension of section 26 adjacent outhaul winch assembly 22. Second, whenever inhauling trolley 28 and winch assemblies 18 and 22 are controlled to accelerate the trolley 28, irrespective of whether or not trolley 28 is operating as a normal or an overhauling load, the inhaul cable section 24 tension is greater than the outhaul cable section 26 tension. Each of the first two conditions described above wherein the inhaul cable section tension is greater than the outhaul cable section tension correspond to quadrant 3 in FIG. 3.

Referring yet again to FIG. 3, a third set of circumstances in which the inhaul cable section 24 tension is greater than the outhaul cable section 24 tension occurs whenever trolley 28 is moved in an outhaul direction and operates as an overhauling load. In this regard, referring again to FIG. 1, when trolley 28 is moved in outhaul direction 32 and is moving downward from inhaul winch assembly 18 to pulley 20, the tension of cable section 24 proximate inhaul winch assembly 18 is greater than the tension of cable section 26 proximate outhaul winch assembly 22. Fourth, when trolley 28 is moving in an outhaul direction and winch assemblies 18 and 22 are controlled to decelerate trolley 28, irrespective of whether or not trolley 28 is operating as an overhauling load or a normal load on winch assemblies 18 and 22, the inhaul cable section 26 tension is greater than the outhaul cable section 26 tension. The third and fourth sets of circumstances under which the inhaul cable section tension is greater than the outhaul cable section tension described above correspond to quadrant 4 in FIG. 3.

Referring still to FIGS. 1 and 2, and also again to FIG. 4, according to one aspect of the present invention, two separate cable speed sensors 100 and 104 are provided wherein the first speed sensor 104 senses the speed of cable section 24 proximate the inhaul winch 18 and the second sensor 100 senses the speed of the cable section 26 proximate outhaul assembly 22. These cable speed signals are fed back to a winch assembly controller and used thereby to adjust winch operation so that trolley speed is maintained at the speed selected by a system operator via speed selector 52.

According to one aspect of the present invention, which speed feedback signal, the inhaul or the outhaul speed feedback signal, is used to adjust winch operation, is a function of the operating characteristics of the winch assembly as a whole. More specifically, which feedback signal is used by the controller to adjust winch operation depends upon in which of the four quadrants illustrated in FIG. 3 the system is operating. In this regard, when the system is operating in either of the acceleration/normal load quadrants, quadrants 1 and 3, it has been recognized that either of the inhaul cable speed or the outhaul cable speed can, theoretically, be utilized as an accurate trolley speed feedback signal. Referring once again to FIG. 1, when moving trolley 28 in inhaul direction 30 and not decelerating, the speeds of cable sections 24 and 26 will be essentially identical and hence which speed feedback is used to adjust winch control is irrelevant. Similarly, referring to FIG. 2, when trolley 28 is moved in outhaul direction 36 and is not being decelerated, the speeds of cable sections 24 and 26 will be essentially identical and which speed feedback is used for control purposes will be irrelevant.

Referring again to FIG. 3, when system operation is in either of the deceleration/overhauling load quadrants, quadrants 2 or 4, the speed of the cable section being wound or taken up cannot be used as a speed feedback signal because the speed of the take up cable section is not a reliable reflection of trolley speed. For example, referring again to FIG. 1, when trolley 28 is moving in outhaul direction 32 and is operating as an overhauling load, winch assembly 18 operates as the braking mechanism against the overhauling load thereby maintaining trolley speed while outhaul winch assembly 22 simply takes up slack. Referring again to FIG. 2, similarly, when moving trolley 28 in inhaul direction 35 while trolley 28 operates as an overhauling load, outhaul winch assembly 22 operates as a brake on trolley 28 speed while inhaul winch 18 simply operates to take up cable slack.

Thus, when a system operates in either quadrants 2 or 4 in FIG. 3, it is necessary to use the speed of the cable corresponding to the winch assembly letting out cable as the feedback for speed regulation. Referring again to FIG. 3, this means that during quadrant 4 operation the speed of cable section 24 proximate inhaul winch assembly 18 must be used as the speed feedback and, when operating in quadrant 2, the speed of cable section 26 proximate outhaul winch assembly 22 must be used as the speed feedback signal for speed regulation.

Referring yet again to FIG. 3, it should be appreciated that which speed feedback signal can be used to regulate winch assembly speeds is dependent upon two factors. First, which feedback signal can be used depends upon whether or not the trolley is inhauling or outhauling. Second, which feedback signal can be used depends on whether or not trolley 28 is operating as an overhauling load or is being decelerated on one hand or, is operating as a normal load or is being accelerated on the other hand.

Whether or not the trolley is moving in the inhaul direction or the outhaul direction is easy to determine. In this regard, the speed command signal S* generated by selector 52 (see again FIG. 4) can be used determine whether or not the trolley is outhauling or inhauling. Where speed command signal S* is positive, the trolley is being moved in the outhaul direction and, where speed command signal S* is negative, the trolley is being moved in the inhaul direction.

Unfortunately, it is more difficult to accurately determine whether or not the trolley is operating as an overhauling load or as a normal load and, whether or not the trolley is being accelerated or decelerated. To this end, referring again to FIG. 2, it should be appreciated that during an initial stage of transferring a trolley 28 from replenishment ship 12 to receiving ship 37, despite the fact that pulley assembly 38 may be vertically higher than inhaul winch assembly 18, the trolley 28 may initially operate as an overhauling load on winch assembly 18 if there is slack in the cable 27. After traveling in direction 36 for some time, trolley 28 may in fact operate as a normal load on winch assembly 18, once trolley 28 is vertically higher than assembly 18.

Applicants have recognized that, while it is possible for system control to jump from any of the four quadrants illustrated in FIG. 3 into any of the other four quadrants illustrated, under normal operating conditions, most transitions will be between quadrants 1 and 4 or between quadrants 2 and 3. Thus, when moving trolley 28 in an outhauling direction, typically, the outhauling direction will not change and instead, trolley speed may be altered, the loading effect of the trolley (e.g., normal or overhauling) may change, etc. Similarly, when operating in the inhaul direction, while various operating parameters and the loading effect of the trolley may change, the inhauling direction will typically remain the same.

Realizing that the outhauling and inhauling directions generally remain the same during system operation and that there is no easy way to determine whether or not the trolley is operating as a normal load or an overhauling load, a simplified control algorithm has been selected according to at least some embodiments of the present invention wherein, which speed feedback is selected, depends only upon the polarity of speed command signal S* (i.e., depends only upon whether or not the trolley is moving in the outhauling or inhauling direction). Referring again to FIG. 3, because transitions between quadrants 1 and 4 are common and either the inhaul or outhaul cable speed may be used as a feedback signal in quadrant 1 while only the inhaul cable speed can be used as a feedback signal in quadrant 4, in at least some embodiments of the invention, whenever trolley 28 is being moved in the outhauling direction, the feedback signal used for speed regulation is the inhaul speed feedback signal. Similarly, because transitions between quadrants 2 and 3 are common and either the inhaul or the outhaul speed feedback signal can be used for speed regulation in quadrant 3 while only the outhaul speed feedback signal can be used for speed regulation in quadrant 2, in at least some embodiments, whenever trolley 28 is being moved in the inhaul direction, the outhaul speed feedback signal is selected for speed regulation purposes. Table 1 below summarizes operating characteristics and which sensors to use in at least some embodiments for speed feedback.

TABLE 1

| | | | Speed | |
|---|---|---|---|---|
| | | | Sensors | Sensor |
| | | | Useable To | Used To |
| | | | Accurately | Accurately |
| Quad- | Cable | Measure | Measure | |
| rant | Trolley Speed | Tension | Speed | Speed |
| 1 | Outhauling Acceleration | Outhaul > | Inhaul or | Inhaul |
| | and Normal Load | Inhaul | Outhaul | Speed |
| | (Sfb < S*) | | Speed | Sensor |
| | | | Sensor | |
| 2 | Inhauling Deceleration | Inhaul > | Outhaul | Outhaul |
| | and Overhauling Load | Outhaul | Speed | Speed |
| | (Sfb < S*) | | Sensor | Sensor |
| 3 | Inhauling Acceleration | Inhaul > | Inhaul or | Outhaul |
| | and Normal Load | Outhaul | Outhaul | Speed |
| | (Sfb < S*) | | Speed | Sensor |
| | | | Sensor | |
| 4 | Outhauling Deceleration | Outhaul > | Inhaul | Inhaul |
| | and Overhauling Load | Inhaul | Speed | Speed |
| | (Sfb > S*) | | Sensor | Sensor |

C. Exemplary Control System

Referring to FIG. 4, an exemplary control system 50 according to the present invention is illustrated. System 50 includes speed selector 52, minimum tension selector 80, two analog-to-digital (A/D) converters 54 and 81, two frequency-to-digital (F/D) converters 62 and 66, a dead band regulator 56, a speed feedback determiner 64, three summers 58, 76 and 78, one proportional-integral (PI) regulator 60, an inverter 70, two maximum value selectors 68 and 72, two multipliers 74 and 82, two digital-to-analog converters 84 and 86, two electrical-pneumatic (E/P) controllers 88 and 90, an inhaul speed sensor 104 and an outhaul speed sensor 100. In addition to the elements described above, motor 102 is coupled to inhaul and outhaul drums 96 and 94, respectively, by inhaul and outhaul clutch assemblies 98 and 92, respectively. The E/P controllers 88 and 90 control clutches 92 and 98, respectively, thereby altering the torques on and speeds of drums 94 and 96, respectively.

Speed selector 52 is used to select command speed S* which is a voltage within a specific range (e.g., between positive and negative 10 volts). Command speed signal S* is provided to A/D converter 54 which converts the analog voltage signal into a digital signal. The digital signal is provided to dead band regulator 56. As its label implies, regulator 56 provides a dead band between trolley inhaul and trolley outhaul command signals wherein, when the command signal S* is within a small range of values around a zero value, the dead band regulator causes a zero command value to be generated. This dead band in speed regulation results in a system wherein transitions between one of the first and fourth quadrants of operation and one of the second and third quadrants operation as illustrated in FIG. 3 will not occur. The command signal S* output by dead band regulator 56 is provided to each of summer 58 and speed feedback determiner 64.

Outhaul and inhaul speed feedback signals S_{fbo} and S_{fbi} are fed back from sensors 100 and 104 to F/D converters 62 and 66, respectively. Converts 62 and 66 convert the feedback signals to digital signals which are provided to speed feedback determiner 64. Speed feedback determiner 64 selects one of the speed feedback signals S_{fbo} or S_{fbi} as a speed feedback signal S_{fb} to be used for speed regulation purposes. Where speed command signal S* is positive, determiner 64 selects the inhaul speed feedback signal S_{fbi} and passes that signal as the feedback signal S_{fb} to summer 58. Where speed command signal S* is negative, determiner 64 passes the outhaul feedback signal S_{fbo} as the speed feedback signals S_{fb} to summer 58.

Summer 58 subtracts the speed feedback signal S_{fb} from the speed command signal S* and generates a speed error signal Sₑ which is provided to PI regulator 60. Regulator 60 steps up speed error signal Sₑ and provides the stepped up signal to each of inverter 70 and maximum value selector 68. As its label implies, inverter 70 negates the stepped up speed error signal received from PI regulator 60 and provides the negated signal to maximum value selector 72.

Each of the maximum value selectors 68 and 72, as their labels imply, selects the maximum one of two values that are input into the selector. In addition to the inputs from PI regulator 60 and inverter 70, selectors 68 and 72 are each provided with a zero value as their second inputs. Thus, when the output of PI regulator 60 is positive, maximum value selector 68 passes the output of PI regulator 60 to summer 76 (i.e., selector 68 passes the greater of the output of PI regulator 60 and the zero value to summer 76). In addition, when the output of PI regulator 60 is positive, because inverter 70 negates the output of regulator 60, maximum value selector 72 provides a zero value to summer 78. When the output of PI regulator 60 is negative, maximum value selector 68 outputs a zero value to summer 76 and selector 72 provides the absolute value of the output of PI regulator 60 to summer 78. In this manner, one of selectors 68 or 72 provides a zero value while the other of selectors 68 and 72 provides the absolute value of the output of PI regulator 60. Hereinafter, the outputs of selectors 68 and 72 will be referred to as intermediate outhaul and intermediate inhaul speed signals or values Sᵢₙₜₒ and Sᵢₙₜᵢ, respectively.

Referring still to FIG. 4, tension selector 80 is used to set a minimum tension command value T* which, as described above, takes the form of a positive voltage value within a system range (e.g., the range may be between 0 and 10 volts). Command tension signal T* is provided to A/D converter 81 which converts that value into a digital signal which is provided to multipliers 74 and 82. Outhaul and inhaul tension scaling factors Sfₒ and Sfᵢ are selected by a system operator and are provided to multipliers 74 and 82, respectively. Multiplier 74 multiplies the outhaul scaling factor Sfₒ by the command minimum tension value T* and provides its output to summer 76. Similarly, multiplier 82 multiplies the inhaul scaling factor Sfᵢ by the command tension value T* and provides its output to summer 78.

Summer 76 adds the intermediate outhaul speed signal Sᵢₙₜₒ and the scaled tension value SfₒT* to generate an outhaul torque value Tor₀ which is provided to D/A converter 84. Similarly, summer 78 adds the intermediate inhaul speed signal Sᵢₙₜᵢ and the scaled inhaul tension command signal SfᵢT* to generate an inhaul torque value Torᵢ which is provided to D/A converter 86.

Converters 84 and 86 convert their received signals to analog signals which are provided to E/P controllers 88 and 90, respectively. Controllers 88 and 90 control clutches 92 and 98, respectively, and thereby control speeds of winch drums 94 and 96, respectively.

Thus, referring still to FIGS. 1 and 4, assume winch assemblies 18 and 22 are being operated to move trolley 28 in outhaul direction 32 toward ship 14 (i.e., command speed S* is positive). Also assume that trolley 28 is moving at a speed greater than the commanded speed S*. In this case, because the commanded speed S* is positive, regulator 64 selects the inhaul speed feedback signal. Inhaul speed feedback signal S_{fib} is subtracted from speed value S* yielding a negative value (i.e., S_{fbi}>S*). The negative output of PI regulator 60 causes selectors 68 and 72 to output a zero value and a positive value, respectively. The zero value is added to the scaled tension value SFₒT* and has no effect on outhaul torque signal Torₒ. However, the positive value from selector 72 steps up the ultimate inhaul torque value Torᵢ thereby causing the inhaul winch to reduce its speed and in turn to reduce trolley speed.

Referring still to FIGS. 1 and 4, during outhauling, if inhaul speed feedback signal S_{fbi} is less than commanded speed S*, an exact opposite torque adjustment occurs wherein the outhaul torque value Torₒ is stepped up and the initial torque value is set solely as a function of the scaled minimum torque value SFᵢT*. Similarly, if feedback value S_{fbo} has a magnitude that is less than the magnitude of command speed S*, speed error value Sₑ output by summer 58 is negative causing selector 78 to increase inhaul torque value Torᵢ while outhaul torque value Torₒ is tied to scaled tension value SFₒT*.

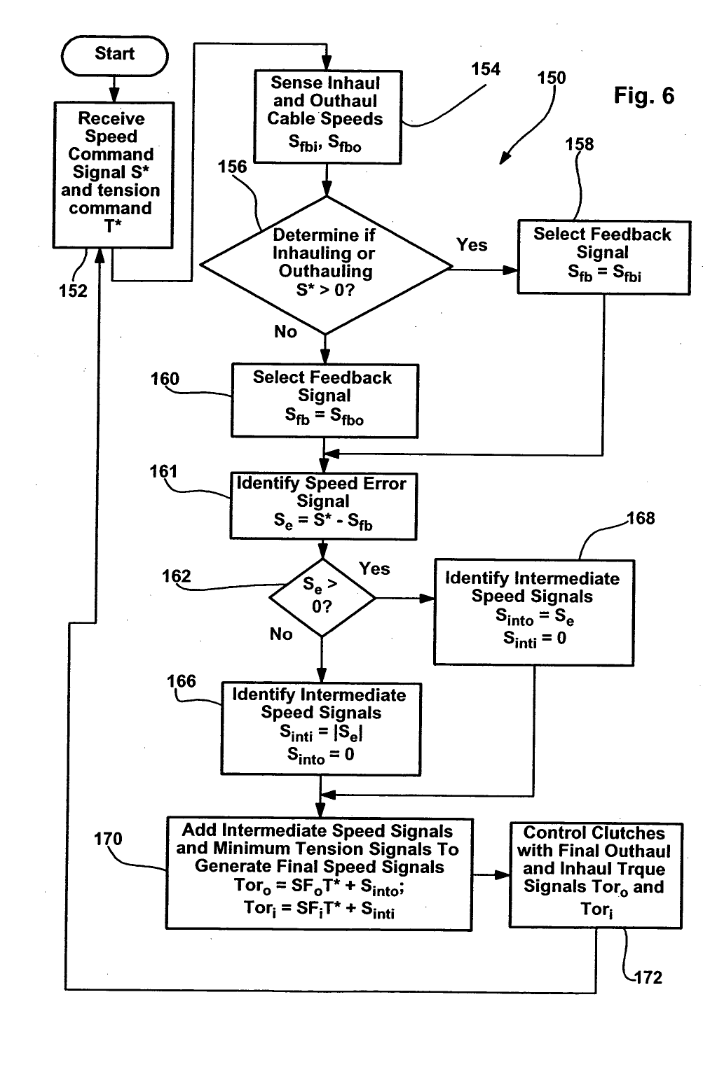

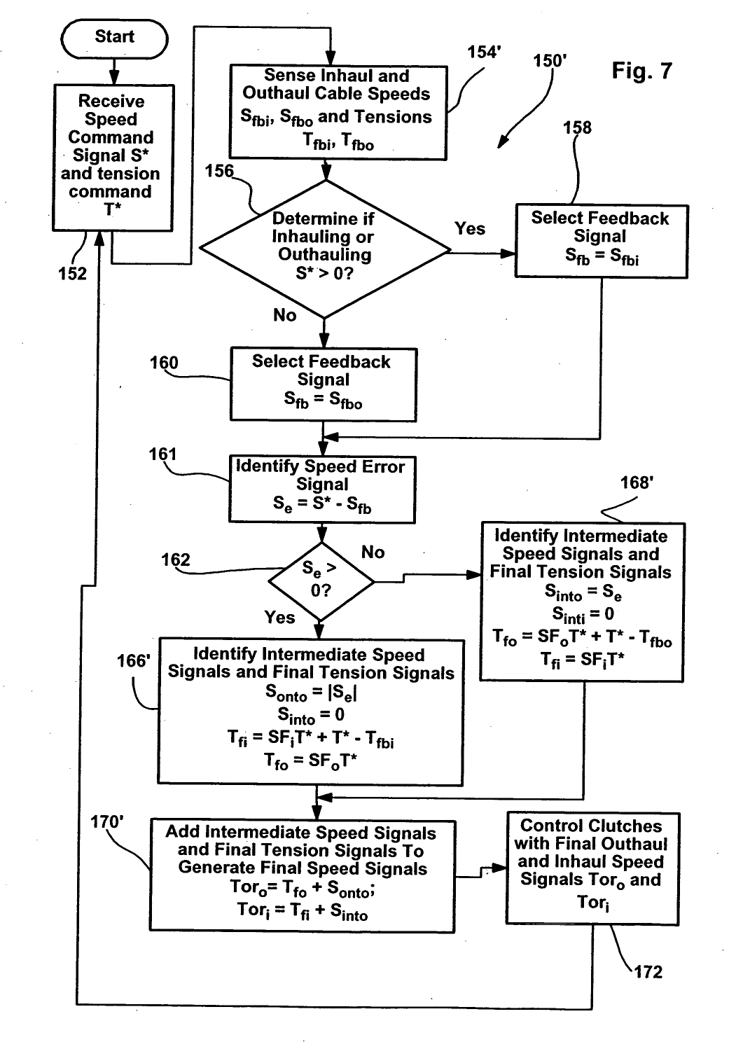

Referring now to FIG. 6, an inventive method 150 that is performed by the control assembly illustrated in FIG. 4 is shown. Beginning at block 152, speed command signal S* and tension command signal T* are received. At block 154, both the outhaul and inhaul cable speeds are sensed and outhaul and inhaul speed feedback signals S_{fbo} and S_{fbi} are provided. At block 156, the controller determines if the system is inhauling or outhauling by comparing command speed S* to a zero value. Where command speed S* is greater than zero and hence trolley 28 is moving in the outhaul direction, control passes to block 158 where the controller selects inhaul feedback speed signal S_{fbi} as the speed feedback signal S_{fb}. In the alternative, where command speed S* is less than zero and hence trolley 28 is moving in the inhaul direction, control passes to block 160 where the speed feedback signal S_{fb} is set equal to the outhaul feedback signal S_{fbo}. After either block 160 or 158, control passes to block 161.

At block 161 a speed error signal is determined by subtracting the speed feedback signal S_{fb} from command signal S*. At block 162 speed error signal Sₑ is compared to zero. Where speed error signal Sₑ is positive, control passes to block 168 where the intermediate outhaul speed signal Sᵢₙₜₒ is set equal to the error signal Sₑ and the intermediate inhaul speed signal Sᵢₙₜᵢ is set equal to zero. If speed error signal Sₑ at block 162 is negative, control passes to block 166 where the intermediate inhaul speed signal is set equal to the absolute value of the speed error signal Sₑ and the intermediate outhaul signal Sᵢₙₜₒ is set equal to zero. After either of blocks 166 or 168, control passes to block 170.

At block 170, the intermediate outhaul speed signal is added to the minimum tension signal for the outhaul winch and the intermediate inhaul speed signal is added to the minimum tension of the inhaul winch thereby generating outhaul and inhaul torque signals Torₒ and Torᵢ, respectively. At block 172, the outhaul and inhaul torque signals are used to control the winches. After block 172, control again passes back up to block 162 where the process is repeated.

D. Closed Loop Control System

While an open tension loop embodiment of the present invention is described above, the present invention also contemplates a system having a closed tension loop. To this end, referring to FIG. 5, various components that may be used to supplement and replace several of the components of FIG. 4 are illustrated. In FIG. 5, components that are similar or identical to the components illustrated in FIG. 4 are identified by the same numbers. Components unique to the embodiment of FIG. 5 include inhaul and outhaul cable tension sensors 132 and 134, first and second tension determiners 112 and 122, additional summers 114 and 124 and two additional PI regulators 116 and 126.

Maximum value selectors 68 and 72 in FIG. 5 operate in the manner described above with respect to FIG. 4 to generate intermediate outhaul and inhaul speed signals Sᵢₙₜₒ and Sᵢₙₜᵢ, respectively, and therefore will not be described here in detail. Similarly, components 80, 81, 74 and 82 operate in the manner described above and hence will not be described again in detail.

Tension sensor 132 is mounted proximate inhaul winch assembly 18 for measuring the tension of inhaul cable section 24 and generates an inhaul tension feedback signal T_{fbi}. Similarly, sensor 134 is mounted proximate outhaul winch assembly 22 for measuring the tension of outhaul cable section 26 and generates an outhaul tension feedback signal T_{fbo}.

In addition to being provided to multipliers 74 and 82, the digital tension command signal T* is also provided to first and second tension determiners 112 and 122. Referring to FIGS. 4 and 5, first tension determiner 112 also receives the stepped up speed error signal from PI regulator 60 as well as the outhaul tension feedback signal T_{fbo} from outhaul cable tension sensor 134. Second tension determiner 122 receives the output of inverter 70 and the tension feedback signal T_{fbi} from tension sensor 132.

Referring still to FIG. 5, when the output of PI regulator 60 is negative, first tension determiner 112 outputs tension command signal T* as a reference signal to summer 114 while second tension determiner 122 outputs inhaul tension feedback signal T_{fbi} as a reference signal to summer 124. In the alternative, when the output of PI regulator 60 is positive, first tension determiner 112 provides outhaul tension feedback signal T_{fbo} from sensor 134 as a reference signal to summer 114 while second tension determiner 122 provides command tension signal T* as a reference signal to summer 124.

In addition to receiving the output from first tension determiner 112, summer 114 also receives outhaul tension feedback signal T_{fbo} and subtracts feedback signal T_{fbo} from the reference signal thereby generating an intermediate outhaul tension signal Tᵢₙₜₒ. Similarly, summer 124 receives inhaul tension feedback signal T_{fbi} from sensor 132 and subtracts signal T_{fbi} from the reference signal received from determiner 122 thereby generating an intermediate inhaul tension signal Tᵢₙₜᵢ. Intermediate signals Tᵢₙₜₒ and Tᵢₙₜᵢ are provided to PI regulators 116 and 126, respectively, which step up those signals and provide the stepped up signals to summers 120 and 130, respectively. Summer 120 adds the received stepped up signal to scaled tension command signal SfₒT* thereby generating a final outhaul tension signal T_{fo}. Similarly, summer 130 adds the received stepped up signal to scaled tension command signal SfᵢT* thereby generating a final inhaul tension signal T_{fi}.

The final outhaul and inhaul tension signals T_{fo} and T_{fi} are provided to summers 76 and 78, respectively. Summers 76 and 78 add the final tension values to the intermediate outhaul and inhaul speed signals Sᵢₙₜₒ and Sᵢₙₜᵢ thereby generating outhaul and inhaul torque signals Torₒ and Torᵢ, respectively. Final signals Torₒ and Torᵢ are provided to D/A converters 84 and 86 as illustrated in FIG. 4.

Thus, when speed error Sₑ is negative, the difference between the minimum tension command value T* and the outhaul feedback tension signal T_{fbo} is used to adjust the rate at which the outhaul torque is increased. For instance, if the outhaul feedback torque T_{fbo} is less than the minimum torque command T*, the rate of outhaul torque change is increased and if the outhaul feedback torque T_{fbo} is greater than the minimum torque command T*, the rate of outhaul torque change is decreased.

Similarly, when speed error Sₑ is positive, the differential between the command value T* and the inhaul feedback tension signal T_{fbi} difference is used to adjust the rate at which the inhaul torque is increased (e.g., a positive T*−T_{fbi} differential causes the rate of torque increase to be increased and a negative differential causes a decrease in the rate).

Referring now to FIGS. 4, 5 and 7, a process 150 that may be performed by a controller assembly including the components of FIG. 5 is illustrated in FIG. 7. In FIG. 7, many of the steps described above with respect to FIG. 6 are identical, are identified by identical numbers and will not be explained again here in detail in the interest of simplifying this explanation. The blocks in FIG. 7 that are similar but not identical to the blocks in FIG. 6 are identified by the same numbers followed a “′”. In FIG. 7, after block 152, control passes to block 154′ where, in addition to receiving the inhaul and outhaul cable speeds, the controller also receives the inhaul and outhaul cable tension signals T_{fbi} and T_{fbo}, respectively. After block 154′, the functions corresponding to blocks 156, 158, 160,161 and 162 are identical to the process blocks described above with respect to FIG. 6.

At block 162, where the speed error Sₑ is negative, control passes to block 168′ where, in addition to identifying the intermediate speed signals, the controller also identifies the final outhaul and final inhaul tension signals T_{fo} and T_{fi}, as illustrated. Where the speed error signal Sₑ is positive, control passes to block 166′ where the intermediate speed signals are identified and the final outhaul and inhaul tension signals are identified by solving the equations illustrated. After either of block 166′ or block 168′, control passes to block 170′ where the intermediate speed signals and final tension signals are added together according to the illustrated equations thereby generating final outhaul and inhaul torque signals Torₒ and Torᵢ, respectively. At block 172, the final torque signals are used to control the clutches and thereafter control passes back up to block 152 where the process is repeated.

It should be understood that the methods and apparatuses described above are only exemplary and do not limit the scope of the invention, and that various modifications could be made by those skilled in the art that would fall under the scope of the invention.

To apprise the public of the scope of this invention, the following claims are made:

1. An apparatus for use with a transfer system for transferring a trolley between first and second stations, the system including an inhaul winch, an outhaul winch, a cable and a trolley, the inhaul winch mounted to the first station, the outhaul winch mounted to one of the first and second stations, the cable extending between the first and second stations and between the inhaul and outhaul winches and the trolley mounted to the cable, the assembly for controlling trolley speed during transfer between the first and second stations and comprising:
a speed selector for setting a command speed value;
a speed sensor assembly sensing the speed of the cable and providing a speed feedback value; and
a speed regulator regulating the speeds of the inhaul and the outhaul winches as a function of the command speed value and the speed feedback value.

2. The apparatus of claim 1 wherein the speed sensor assembly includes an inhaul speed sensor, an outhaul speed sensor and a feedback determiner, the inhaul speed sensor sensing the speed of the cable proximate the inhaul winch and generating an inhaul speed feedback signal and the outhaul speed sensor sensing the speed of the cable proximate the outhaul winch and generating an outhaul speed feedback signal, the feedback determiner selecting one or the other of the inhaul and outhaul speed feedback signals as the speed feedback value.

3. The apparatus of claim 2 wherein, when the winches are moving the trolley from the first station toward the second station, the feedback determiner selects the inhaul speed feedback signal as the speed feedback value and, when the winches are moving the trolley from the second station toward the first station, the feedback determiner selects the outhaul speed feedback signal as the speed feedback value.

4. The apparatus of claim 1 further including a pulley mounted to the second station and wherein the outhaul winch is mounted to the first station and the cable passes from the inhaul winch around the pulley and back to the outhaul winch.

5. The apparatus of claim 1 wherein the speed sensor assembly includes first and second cable speed sensors for determining the speed of two different sections of the cable.

6. The apparatus of claim 5 wherein the speed sensor assembly further includes a speed feedback determiner for selecting a signal from one of the first and second cable speed sensors as the speed feedback value.

7. The apparatus of claim 6 wherein the first and second speed sensors include an inhaul speed sensor for sensing the speed of the cable proximate the inhaul winch and an outhaul speed sensor for sensing the speed of the cable proximate the outhaul winch, respectively, and, wherein, the speed feedback determiner selects the inhaul sensor signal when the inhaul winch is letting cable out and selects the outhaul sensor signal when the outhaul winch is letting cable out.

8. The apparatus of claim 1 wherein the speed regulator includes a summer that mathematically combines the command speed value and the speed feedback value to generate a speed error value and then uses the speed error value to adjust inhaul and outhaul winch speeds.

9. The apparatus of claim 8 wherein, when the speed error value is positive, the speed regulator uses the speed error value as an intermediate outhaul speed value to control the outhaul winch and a zero intermediate inhaul speed value to control the inhaul winch and, when the speed error value is negative, the speed regulator uses the speed error value as an intermediate inhaul speed value to control the inhaul winch and a zero intermediate outhaul speed value to control the outhaul winch.

10. The apparatus of claim 9 further including a tension selector for setting a command tension value, the speed regulator mathematically combining the command tension value and the intermediate inhaul speed value to generate an inhaul torque value to control the inhaul winch speed and mathematically combining the command tension value and the intermediate outhaul speed value to generate an outhaul torque value to control the outhaul winch speed.

11. The apparatus of claim 10 further including inhaul and outhaul tension sensors for sensing cable tensions proximate the inhaul and outhaul winches and generating inhaul and outhaul tension feedback values, respectively, when the error signal is negative, the speed regulator mathematically combining to generate the outhaul torque value by:
mathematically combining the command tension value and the outhaul tension feedback value to generate an intermediate outhaul tension value;
mathematically combining the command tension value and the intermediate outhaul tension value to generate a final outhaul tension value; and
mathematically combining the intermediate outhaul speed value and the final outhaul tension value to generate the outhaul torque value; and,
when the error signal is positive, the speed regulator mathematically combining to generate the inhaul torque value by:
mathematically combining the command tension value and the inhaul feedback tension value to generate an intermediate inhaul tension value;
mathematically combining the command tension value and the intermediate inhaul tension value to generate a final inhaul tension value; and
mathematically combining the intermediate inhaul speed value and the final inhaul tension value to generate the inhaul torque value.

12. The apparatus of claim 11 wherein the summer mathematically combines the command speed value and the speed feedback value by subtracting the speed feedback value from the command speed value.

13. The apparatus of claim 1 further including a cable tension selector for selecting a cable tension command value, the speed regulator regulating the speeds of the inhaul and the outhaul winches as a function of the command speed value, the speed feedback value and the cable tension command value.

14. The apparatus of claim 13 further including an inhaul cable tension sensor and an outhaul cable tension sensor for sensing the tension of the cable proximate the inhaul and outhaul winches and generating inhaul and outhaul tension feedback values, respectively, the speed regulator regulating the speeds of the inhaul and the outhaul winches as a function of the command speed value, the speed feedback value, the cable tension command value and the inhaul and outhaul tension feedback values.

15. The apparatus of claim 14 wherein the speed sensor assembly includes first and second cable speed sensors for determining the speeds of two different sections of the cable and wherein the speed sensor assembly further includes a speed feedback determiner for selecting a signal from one of the first and second cable speed sensors as the speed feedback value.

16. An apparatus for use with a transfer system for transferring a trolley between first and second stations, the system including an inhaul winch, an outhaul winch, a cable, a trolley and a pulley, the inhaul winch and outhaul winch mounted to the first station, the pulley mounted to the second station, the cable extending from the inhaul winch to the pulley and back to the outhaul winch and the trolley mounted to the cable, the assembly for controlling trolley speed during transfer between the first and second stations and comprising:
a speed selector for setting a command speed value, the command speed value positive when the winches are operating to move the trolley toward the second station and negative when the winches are operating to move the trolley toward the first station;
an inhaul speed sensor for sensing cable speed proximate the inhaul winch and generating an inhaul speed feedback value;
an outhaul speed sensor for sensing cable speed proximate the outhaul winch and generating an outhaul speed feedback value;
a speed feedback determiner that selects the inhaul speed feedback value as a speed feedback value when the command speed value is positive and selects the outhaul speed feedback value as the speed feedback value when the command speed value is negative; and
a speed regulator that regulates the torques of the inhaul and the outhaul winches as a function of the command speed value and the speed feedback value.

17. The apparatus of claim 16 wherein the speed regulator includes a summer that mathematically combines the command speed value and the speed feedback value to generate a speed error value and uses the speed error value to adjust the inhaul and outhaul winch torques.

18. The apparatus of claim 17 wherein, when the speed error value is positive, the speed regulator uses the speed error value as an intermediate outhaul speed value to control the outhaul winch and a zero intermediate inhaul speed value to control the inhaul winch and, when the speed error value is negative, the speed regulator uses the speed error value as an intermediate inhaul speed value to control the inhaul winch and a zero intermediate outhaul speed value to control the outhaul winch.

19. The apparatus of claim 18 further including a tension selector for setting a command tension value, the speed regulator mathematically combining the command tension value and the intermediate inhaul speed value to generate an inhaul torque value to control the inhaul winch speed and mathematically combining the command tension value and the intermediate outhaul speed value to generate an outhaul torque value to control the outhaul winch speed.

20. The apparatus of claim 19 further including inhaul and outhaul tension sensors for sensing the cable tensions proximate the inhaul and outhaul winches and generating inhaul and outhaul tension feedback values, respectively, the speed regulator using the inhaul and outhaul tension feedback signals to generate the inhaul and outhaul torque values.

21. The apparatus of claim 20 wherein, when the error signal is negative, the speed regulator mathematically combines to generate the outhaul torque value by:
mathematically combining the command tension value and the outhaul tension feedback value to generate an intermediate outhaul tension value;
mathematically combining the command tension value and the intermediate outhaul tension value to generate a final outhaul tension value; and
mathematically combining the intermediate outhaul speed value and the final outhaul tension value to generate the outhaul torque value; and,
when the error signal is positive, the speed regulator mathematically combining to generate the inhaul torque value by:
mathematically combining the command tension value and the inhaul tension feedback value to generate an intermediate inhaul tension value;
mathematically combining the command tension value and the intermediate inhaul tension value to generate a final inhaul tension value; and
mathematically combining the intermediate inhaul speed value and the final inhaul tension value to generate the inhaul feedback value.

22. The apparatus of claim 21 wherein the summer mathematically combines the command speed value and the speed feedback value by subtracting the speed feedback value from the command speed value.

23. A method for use with a transfer system for transferring a trolley between first and second stations, the system including an inhaul winch, an outhaul winch, a cable, a trolley and a pulley, the inhaul winch and outhaul winch mounted to the first station, the pulley mounted to the second station, the cable extending from the inhaul winch to the pulley and back to the outhaul winch and the trolley mounted to the cable, the method for controlling trolley speed during transfer between the first and second stations and comprising the steps of:
providing a command speed value that is positive when the trolley is being moved from the first toward the second station and that is negative when the trolley is being moved from the second to toward the first station;
identifying an inhaul speed feedback value by determining the speed of a section of the cable proximate the inhaul winch;
identifying an outhaul speed feedback value by determining the speed of a section of the cable proximate the outhaul winch;
when the command speed value is positive, selecting the inhaul speed feedback value as a speed feedback value;
when the command speed value is negative, selecting the outhaul speed feedback value as a speed feedback value; and
regulating winch torques as a function of the command speed value and the speed feedback value.

24. The method of claim 23 wherein the step of regulating as a function of the speed feedback value includes subtracting the speed feedback value form the command speed value to generate a speed error value, when the speed error value is positive, increasing the outhaul winch torque and, when the speed error value is negative, increasing the inhaul winch torque.

25. The method of claim 24 further including the step of providing a command tension value and wherein the step of regulating winch torques includes regulating the torques as a function of both the speed error value and the command tension value.

26. The method of claim 25 wherein the step of regulating torques includes, when the speed error value is positive, multiplying the command tension value and an inhaul scaling factor to generate an inhaul torque value and using the inhaul torque value to regulate the inhaul winch torque and mathematically combining the command tension value and the speed error value to generate an outhaul torque value and using the outhaul torque value to control the outhaul winch torque and, when the speed error value is negative, multiplying the command tension value and an outhaul scaling factor to generate an outhaul torque value and using the outhaul torque value to regulate the outhaul winch torque and mathematically combining the command tension value and the speed error value to generate an inhaul torque value and using the inhaul torque value to control the inhaul winch torque.

27. The method of claim 26 wherein the step of mathematically combining to generate an outhaul torque value includes the step of multiplying the command tension value and an outhaul scaling factor to generate a scaled outhaul tension value and adding the scaled outhaul tension value and the speed error value to generate the outhaul torque value and, wherein, the step of mathematically combining to generate an inhaul torque value includes the step of multiplying the command tension value and an inhaul scaling factor to generate a scaled inhaul value and adding the scaled inhaul value and the speed error value to generate the inhaul torque value.

28. The method of claim 25 further including the steps of identifying an inhaul tension feedback value by determining the tension of a section of the cable proximate the inhaul winch, identifying an outhaul tension feedback value by determining the tension of a section of the cable proximate the outhaul winch and, wherein, the step of regulating torques includes, when the speed error value is positive, mathematically combining the command tension value and the inhaul feedback tension value to generate an inhaul torque value and using the inhaul torque value to regulate the inhaul winch torque and mathematically combining the command tension value and an outhaul scaling factor to generate an outhaul torque value and using the outhaul torque value to regulate the outhaul winch torque and, when the speed error value is negative, mathematically combining the command tension value and the outhaul feedback tension value to generate an outhaul torque value and using the outhaul torque value to regulate the outhaul winch speed and mathematically combining the command tension value and an inhaul scaling factor to generate an inhaul torque value and using the inhaul torque value to regulate the inhaul winch speed.

29. The method of claim 28 wherein the step of mathematically combining the command tension value and the inhaul feedback tension value to generate an inhaul torque value includes mathematically combining the command tension value, the inhaul feedback tension value and an inhaul scaling factor to generate the inhaul torque value and, wherein, the step of mathematically combining the command tension value and the outhaul feedback tension value to generate an outhaul torque value includes mathematically combining the command tension value, the outhaul feedback tension value and an outhaul scaling factor to generate the outhaul torque value.

30. A transfer assembly for transferring between first and second stations, the assembly comprising:
an inhaul winch mounted to the first station;
an outhaul winch mounted to one of the first and second stations;
a cable extending between the first and second stations and between the inhaul and outhaul winches;
a trolley mounted to the cable;
a speed selector for setting a command speed value;
a speed sensor assembly sensing the speed of the cable and providing a speed feedback value; and
a speed regulator regulating the speeds of the inhaul and the outhaul winches as a function of the command speed value and the speed feedback value.

31. The assembly of claim 30 wherein the speed sensor assembly includes first and second cable speed sensors for determining the speed of two different sections of the cable.

32. The assembly of claim 31 wherein the speed sensor assembly further includes a speed feedback determiner for selecting a signal from one of the first and second cable speed sensors as the speed feedback value.

33. The assembly of claim 32 wherein the first and second speed sensors include an inhaul speed sensor for sensing the speed of the cable proximate the inhaul winch and an outhaul speed sensor for sensing the speed of the cable proximate the outhaul winch, respectively, and, wherein, the speed feedback determiner selects the inhaul sensor signal when the inhaul winch is letting cable out and selects the outhaul sensor signal when the outhaul winch is letting cable out.

34. The assembly of claim 30 wherein the speed regulator includes a summer that mathematically combines the command speed value and the speed feedback value to generate a speed error value and then uses the speed error value to adjust inhaul and outhaul winch speeds.

35. The assembly of claim 34 wherein, when the speed error value is positive, the speed regulator uses the speed error value as an intermediate outhaul speed value to control the outhaul winch and a zero intermediate inhaul speed value to control the inhaul winch and, when the speed error value is negative, the speed regulator uses the speed error value as an intermediate inhaul speed value to control the inhaul winch and a zero intermediate outhaul speed value to control the outhaul winch.

36. The assembly of claim 35 further including a tension selector for setting a command tension value, the speed regulator mathematically combining the command tension value and the intermediate inhaul speed value to generate an inhaul torque value to control the inhaul winch speed and mathematically combining the command tension value and the intermediate outhaul speed value to generate an outhaul torque value to control the outhaul winch speed.

37. The assembly of claim 36 further including inhaul and outhaul tension sensors for sensing cable tensions proximate the inhaul and outhaul winches and generating inhaul and outhaul tension feedback values, respectively, when the error signal is negative, the speed regulator mathematically combining to generate the outhaul torque value by:
mathematically combining the command tension value and the outhaul tension feedback value to generate an intermediate outhaul tension value;
mathematically combining the command tension value and the intermediate outhaul tension value to generate a final outhaul tension value; and
mathematically combining the intermediate outhaul speed value and the final outhaul tension value to generate the outhaul torque value; and,
when the error signal is positive, the speed regulator mathematically combining to generate the inhaul torque value by:
mathematically combining the command tension value and the inhaul feedback tension value to generate an intermediate inhaul tension value;
mathematically combining the command tension value and the intermediate inhaul tension value to generate a final inhaul tension value; and
mathematically combining the intermediate inhaul speed value and the final inhaul tension value to generate the inhaul torque value.

38. The assembly of claim 37 wherein the summer mathematically combines the command speed value and the speed feedback value by subtracting the speed feedback value from the command speed value.

39. The assembly of claim 30 further including a cable tension selector for selecting a cable tension command value, the speed regulator regulating the speeds of the inhaul and the outhaul winches as a function of the command speed value, the speed feedback value and the cable tension command value.

40. The assembly of claim 39 further including an inhaul cable tension sensor and an outhaul cable tension sensor for sensing the tension of the cable proximate the inhaul and outhaul winches and generating inhaul and outhaul tension feedback values, respectively, the speed regulator regulating the speeds of the inhaul and the outhaul winches as a function of the command speed value, the speed feedback value, the cable tension command value and the inhaul and outhaul tension feedback values.

41. The assembly of claim 40 wherein the speed sensor assembly includes first and second cable speed sensors for determining the speeds of two different sections of the cable and wherein the speed sensor assembly further includes a speed feedback determiner for selecting a signal from one of the first and second cable speed sensors as the speed feedback value.
